(19) United States
(12) Patent Application Publication
(10) Pub. No.: US 2019/0131857 A1
(43) Pub. Date: May 2, 2019

(54) MOTOR

(71) Applicant: Nidec Corporation, Kyoto (JP)

(72) Inventor: Naohiro NAGASAWA, Kyoto (JP)

(21) Appl. No.: 16/145,306

(22) Filed: Sep. 28, 2018

(30) Foreign Application Priority Data
Oct. 26, 2017 (JP) 2017-207138

(51) Int. Cl. H02K 21/22; H02K 7/04

(52) U.S. Cl. CPC H02K 21/222; H02K 7/04

(57) ABSTRACT

A motor includes a stationary portion including a stator, and a rotating portion supported to be rotatable about a central axis extending in a vertical direction with respect to the stationary portion. The rotating portion includes a rotor hub portion extending in an annular shape around the central axis, a magnet including a pole surface radially opposite to the stator, a yoke fixed to a radial outside of the magnet and connected to the rotor hub portion, a first seal portion extending in an annular shape around the yoke, and a flywheel located on one side of the rotor hub portion in an axial direction. At least a portion of a lower surface of the yoke defines a first metal surface that has a reflectivity higher than a reflectivity of an outer circumferential surface of the flywheel and a reflectivity of the first seal portion. At least a portion of the first metal surface is covered with the first seal portion.

### CROSS REFERENCE TO RELATED APPLICATIONS

This application claims the benefit of priority to Japanese Patent Application No. 2017-207138 filed on Oct. 26, 2017. The entire contents of this application are hereby incorporated herein by reference.

### BACKGROUND OF THE INVENTION

### 1. Field of the Invention

The present invention relates to a motor.

### 2. Description of the Related Art

A motor for use in a DLP (digital light processing) single-chip projector is described in JP-A 2005-278309. In this projector, light emitted from a light source passes through a color wheel that rotates along with rotation of the motor. The light passing through the color wheel is converted into light in one of RGB bands. This light impinges on a digital micromirror device, and then, the light reflected from the digital micromirror device is guided onto a predetermined screen to display an image on the screen.

Like the motor described in JP-A 2005-278309, a motor for use in an apparatus designed to guide light is required to prevent a diffuse reflection of light by an outer circumferential surface of the motor. The motor described in JP-A 2005-278309, in particular, includes a yoke, which is generally defined by a member made of a metal. Thus, a diffuse reflection of light tends to easily occur because of a metal surface of the yoke.

### SUMMARY OF THE INVENTION

A motor according to a preferred embodiment of the present invention includes a stationary portion including a stator, and a rotating portion supported to be rotatable about a central axis extending in a vertical direction with respect to the stationary portion. The rotating portion includes a rotor hub portion extending in an annular shape around the central axis; a magnet including a pole surface radially opposite to the stator; a yoke fixed to a radial outside of the magnet, and connected to the rotor hub portion; a first seal portion extending in an annular shape around the yoke; and a flywheel on one side of the rotor hub portion in an axial direction. At least a portion of a lower surface of the yoke defines a first metal surface made of a metal. The first metal surface has a reflectivity higher than a reflectivity of an outer circumferential surface of the flywheel and a reflectivity of the first seal portion. At least a portion of the first metal surface is covered with the first seal portion.

The above preferred embodiment of the present invention is able to achieve a reduction in reflection of light by a surface of the yoke of the rotating portion.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a vertical sectional view of a motor according to a first preferred embodiment of the present invention.

FIG. 2 is a partial vertical sectional view of the motor according to the first preferred embodiment of the present invention.

FIG. 3 is a vertical sectional view of a sleeve according to the first preferred embodiment of the present invention.

FIG. 4 is a bottom view of the sleeve according to the first preferred embodiment of the present invention.

FIG. 5 is a partial vertical sectional view of a motor according to a modification of the first preferred embodiment of the present invention.

FIG. 6 is a vertical sectional view of a motor according to a modification of the first preferred embodiment of the present invention.

FIG. 7 is a vertical sectional view of a motor according to a modification of the first preferred embodiment of the present invention.

### DETAILED DESCRIPTION OF THE PREFERRED EMBODIMENTS

Hereinafter, motors according to preferred embodiments of the present invention will be disclosed. It is assumed herein that a direction parallel to a central axis of a motor is referred to by the term “axial direction”, “axial”, or “axially”, that directions perpendicular to the central axis of the motor are each referred to by the term “radial direction”, “radial”, or “radially”, and that a direction along a circular arc centered on the central axis of the motor is referred to by the term “circumferential direction”, “circumferential”, or “circumferentially”. It is also assumed herein that an axial direction is a vertical direction, and that a side on which a flywheel is arranged with respect to a rotor hub portion is an upper side, and the shape of each member or portion and relative positions of different members or portions will be described based on the above assumptions. It should be noted, however, that the above definitions of the vertical direction and the upper and lower sides are not meant to restrict in any way the orientation of a motor according to any preferred embodiment of the present invention at the time of manufacture or when in use.

### 1. First Preferred Embodiment

### 1-1. Structure of Motor

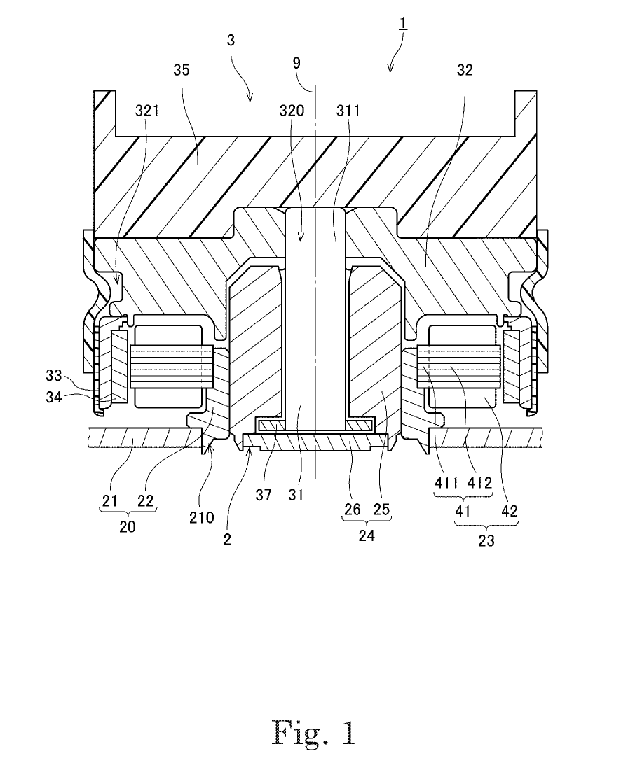

FIG. 1 is a vertical sectional view of a motor 1 according to a first preferred embodiment of the present invention. Referring to FIG. 1, the motor 1 includes a stationary portion 2 and a rotating portion 3. The rotating portion 3 is supported to be rotatable about a central axis 9, which extends in the vertical direction, with respect to the stationary portion 2.

The stationary portion 2 includes a base portion 20, a stator 23, and a bearing portion 24.

The base portion 20 is arranged to support the stator 23, which will be described below. The base portion 20 includes a base body 21 and a stator holder 22.

The base body 21 is a plate-shaped member arranged to support the stator holder 22. A metal, such as, for example, an aluminum alloy or stainless steel, is used as a material of the base body 21. The base body 21 is extending radially outward from an outer circumference of the stator holder 22. When the motor 1 is used, the base body 21 is, for example, fixed to a casing or the like in which the motor 1 is arranged through screws or the like. Note that a circuit board (not shown), which is arranged to supply electric drive currents to the motor 1, may be arranged on or embedded in an upper surface or a lower surface of the base body 21.

The stator holder 22 is a cylindrical member extending in the axial direction. A lower end portion of the stator holder 22 is inserted in a through hole 210 of the base body 21, and is fixed to the base body 21 by crimping. Note, however, that the stator holder 22 may alternatively be fixed to the base body 21 by another method, such as, for example, welding. Also note that the base body 21 and the stator holder 22 may alternatively be defined by a single continuous monolithic member.

The stator 23 is an armature including a stator core 41 and a plurality of coils 42. The stator 23 is arranged above at least a portion of the base portion 20. The stator core 41 is defined by, for example, laminated steel sheets, that is, electromagnetic steel sheets, such as silicon steel sheets, placed one upon another in the axial direction. The stator core 41 is directly supported by the base portion 20 by being fixed to an outer circumferential surface of the stator holder 22 through, for example, an adhesive. Note that the stator 23 may alternatively be indirectly supported by the base portion 20 with another member (not shown) interposed therebetween.

In addition, the stator core 41 includes a core back 411 in the shape of a circular ring, and a plurality of teeth 412 arranged to project radially outward from the core back 411. The coils 42 are a collection of conducting wires wound around the teeth 412. The electric drive currents for the motor 1 are supplied from an external power supply (not shown) to the coils 42 through the aforementioned circuit board and the conducting wires. The teeth 412 and the coils 42 are preferably arranged in the form of a circular ring and at substantially regular intervals in a circumferential direction about the central axis 9.

The bearing portion 24 is a member arranged to rotatably support a shaft 31, which will be described below. The bearing portion 24 includes a sleeve 25 extending in the axial direction to assume a substantially cylindrical shape around the shaft 31, and a disk-shaped cap 26 arranged to close an opening at a lower end portion of the sleeve 25. An inner circumferential surface of the sleeve 25 is arranged radially opposite to an outer circumferential surface of the shaft 31. A lower portion of the sleeve 25 is inserted into a space radially inside of the stator holder 22, and is fixed to the stator holder 22 through, for example, an adhesive. An upper end portion of the sleeve 25 is arranged axially above an upper end portion of the stator holder 22 and an upper end portion of the stator 23. The structure of the bearing portion 24 will be described in more detail below.

The rotating portion 3 includes the shaft 31, a rotor hub portion 32, a yoke 33, a magnet 34, a flywheel 35, a first seal portion 61, which will be described below, and a second seal portion 62, which will be described below.

The shaft 31 is a columnar member extending in the axial direction along the central axis 9. The shaft 31 may be defined integrally with the rotor hub portion 32 or be defined by a member separate from the rotor hub portion 32. A metal, such as stainless steel, for example, is used as a material of the shaft 31. The outer circumferential surface of the shaft 31 and the inner circumferential surface of the sleeve 25 are arranged radially opposite to each other with a slight gap therebetween. In addition, a disk-shaped shaft annular portion 37, which is extending radially outward from a lower end portion of the shaft 31, is fixed to a lower portion of the shaft 31. An upper surface of the shaft annular portion 37 and a lower surface of the sleeve 25 are arranged axially opposite to each other with a slight gap therebetween. In addition, a lower surface of the shaft annular portion 37 and an upper surface of the cap 26 are arranged axially opposite to each other with a slight gap therebetween. Note that the shaft 31 and the shaft annular portion 37 may alternatively be defined by a single monolithic member.

The rotor hub portion 32 is a member extending in an annular shape around the central axis 9. A metal, such as, for example, a stainless metal, an aluminum alloy, or the like, is used as a material of the rotor hub portion 32. A through hole 320 passing through the rotor hub portion 32 in the axial direction is defined radially inside of the rotor hub portion 32. An upper end portion 311 of the shaft 31 is press fitted in the through hole 320 of the rotor hub portion 32. Note, however, that the shaft 31 and the rotor hub portion 32 may alternatively be fixed to each other by another method, such as, for example, adhesion or shrink fitting. In addition, a groove portion 321 recessed radially inward is defined in at least a portion of an outer circumferential surface of the rotor hub portion 32. In the outer circumferential surface of the rotor hub portion 32, the groove portion 321 is extending in the circumferential direction over an entire circumferential extent of the rotor hub portion 32.

The yoke 33 is a cylindrical member fixed to a radial outside of the magnet 34, which will be described below, to hold the magnet 34. An outer circumferential surface of the magnet 34 is fixed to an inner circumferential surface of the yoke 33. The yoke 33 is arranged to be substantially coaxial with the central axis 9. An upper end portion of the yoke 33 is fixed to a lower surface of a radially outer portion of the rotor hub portion 32 through an adhesive or by crimping, for example. A magnetic material, such as, for example, iron, is used as a material of the yoke 33. Use of the yoke 33 made of the magnetic material contributes to preventing magnetic flux generated from the magnet 34 from escaping outward.

The magnet 34 is fixed to the inner circumferential surface of the yoke 33 through, for example, an adhesive. A permanent magnet in the shape of a circular ring is used as the magnet 34 according to the present preferred embodiment. The magnet 34 is arranged radially outside of the stator 23. An inner circumferential surface of the magnet 34 includes north and south poles arranged to alternate with each other in the circumferential direction. In addition, the inner circumferential surface of the magnet 34 is arranged radially opposite to a radially outer end surface of each of the plurality of teeth 412 with a slight gap therebetween. That is, the magnet 34 includes a pole surface arranged radially opposite to the stator 23. Note that a plurality of magnets may be used in place of the magnet 34 in the shape of a circular ring. In the case where the plurality of magnets are used, the magnets are arranged on the inner circumferential surface of the yoke 33 such that pole surfaces of the north poles and pole surfaces of the south poles alternate with each other in the circumferential direction.

Once the electric drive currents are supplied to the coils 42 in the motor 1 described above, magnetic flux is generated around each of the teeth 412, which serve as magnetic cores for the coils 42. In addition, a magnetic circuit passing through the stator 23, the magnet 34, and the yoke 33 is defined. Then, interaction between the magnetic flux of the teeth 412 and magnetic flux of the magnet 34 produces a circumferential torque between the stationary portion 2 and the rotating portion 3, so that the rotating portion 3 is caused to rotate about the central axis 9 with respect to the stationary portion 2 through the bearing portion 24.

The flywheel 35 is arranged axially above the rotor hub portion 32. The flywheel 35 is fixed to the rotor hub portion 32 through, for example, an adhesive. Accordingly, the flywheel 35 is arranged to rotate about the central axis 9 together with the rotating portion 3. An ABS resin, which is a thermoplastic resin, for example, is used as a material of the flywheel 35. Note that, instead of the ABS resin, another material, such as, for example, a thermosetting resin or a metal, may alternatively be used as the material of the flywheel 35. Also note that an axial positional relationship between the shaft 31, the rotor hub portion 32, and the flywheel 35 may be different from the axial positional relationship as described above. For example, the rotor hub portion 32 may alternatively be arranged below the base portion 20, with the flywheel 35 being fixed to a lower surface of the rotor hub portion 32. That is, it may be sufficient if the flywheel 35 is arranged on one side of the rotor hub portion 32 in the axial direction.

### 1-2. Structure of Bearing Portion

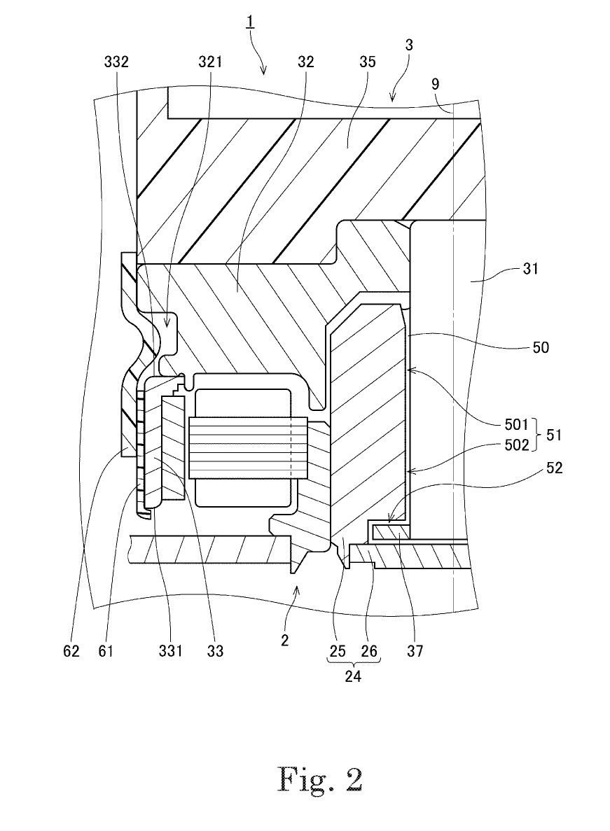

Next, the structure of the bearing portion 24 will now be described in more detail below. FIG. 2 is a partial vertical sectional view of the motor 1. Referring to FIG. 2, the stationary portion 2, which includes the sleeve 25 and the cap 26, and the rotating portion 3, which includes the shaft 31 and the shaft annular portion 37, are arranged opposite to each other with a gap therebetween. A lubricating oil 50 is arranged in the gap. A polyolester oil or a diester oil, for example, is used as the lubricating oil 50.

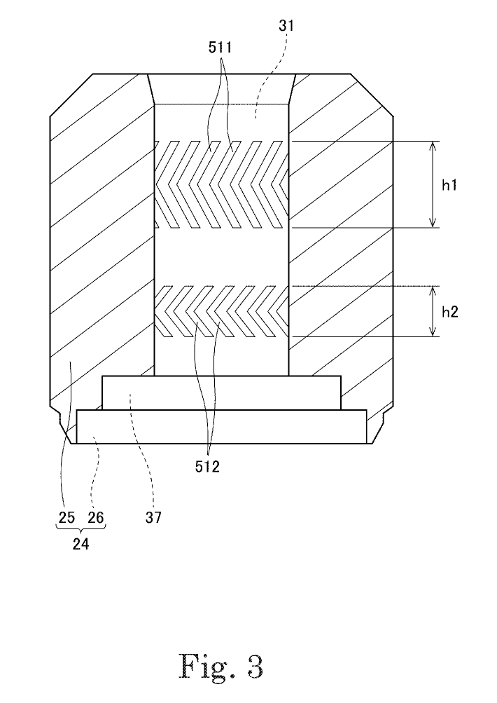

FIG. 3 is a vertical sectional view of the sleeve 25. Referring to FIG. 3, the sleeve 25 includes an upper radial groove array 511 and a lower radial groove array 512 in the inner circumferential surface thereof. The lower radial groove array 512 is arranged axially below the upper radial groove array 511. Each of the upper and lower radial groove arrays 511 and 512 is a groove array arranged in a so-called herringbone pattern. While the motor 1 is running, the upper and lower radial groove arrays 511 and 512 induce a dynamic pressure in a portion of the lubricating oil 50 which is present between the inner circumferential surface of the sleeve 25 and the outer circumferential surface of the shaft 31. This produces a radial supporting force between the sleeve 25 and the shaft 31.

That is, in this motor 1, the inner circumferential surface of the sleeve 25 and the outer circumferential surface of the shaft 31 are arranged radially opposite to each other with the lubricating oil 50 therebetween to define a radial bearing portion 51. In addition, the radial bearing portion 51 includes an upper radial bearing portion 501 arranged to generate a dynamic pressure through the upper radial groove array 511, and a lower radial bearing portion 502 arranged to generate a dynamic pressure through the lower radial groove array 512. The lower radial bearing portion 502 is arranged axially below the upper radial bearing portion 501. Note that it may be sufficient if each of the upper and lower radial groove arrays 511 and 512 is defined in one of the inner circumferential surface of the sleeve 25 and the outer circumferential surface of the shaft 31. Also note that the number of radial dynamic pressure groove arrays may alternatively be one or more than two.

In addition, referring to FIG. 3, in this motor 1, an axial dimension h1 of the upper radial groove array 511 is arranged to be greater than an axial dimension h2 of the lower radial groove array 512. Therefore, an axial dimension of the upper radial bearing portion 501 is greater than an axial dimension of the lower radial bearing portion 502. This causes the lubricating oil 50 to generate a stronger dynamic pressure at a position closer to a center of gravity of the rotating portion 3. This leads to a more stable posture of the rotating portion 3 during the rotation thereof. This in turn leads to a reduction in the likelihood that damage to the rotor hub portion 32 or the like will be caused by wobbling of the rotating portion 3.

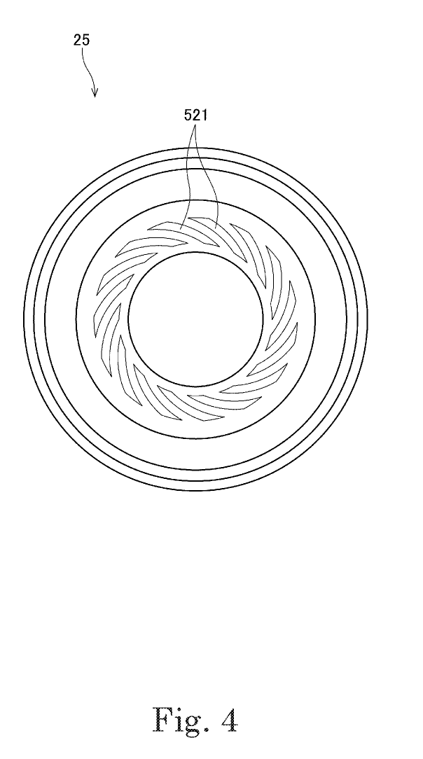

FIG. 4 is a bottom view of the sleeve 25. Referring to FIG. 4, the sleeve 25 includes a thrust groove array 521 in the lower surface thereof. The thrust groove array 521 includes a plurality of thrust grooves arranged in the circumferential direction. The thrust grooves are extending radially in a spiral shape. Note that the thrust groove array 521 may alternatively be arranged in a herringbone pattern. While the motor 1 is running, the thrust groove array 521 induces a fluid dynamic pressure in a portion of the lubricating oil 50 which is present between the lower surface of the sleeve 25 and the upper surface of the shaft annular portion 37. This produces an axial supporting force that supports the shaft annular portion 37 with respect to the sleeve 25, stabilizing the rotation of the rotating portion 3.

That is, in this motor 1, the lower surface of the sleeve 25 of the stationary portion 2 and the upper surface of the shaft annular portion 37 of the rotating portion 3 are arranged axially opposite to each other with a gap in which the lubricating oil 50 exists therebetween to define a thrust bearing portion 52. Note that it may be sufficient if the thrust groove array 521 is defined in one of the lower surface of the sleeve 25 and the upper surface of the shaft annular portion 37. Also note that the number of thrust bearing portions 52 may be two or more. Also note that the thrust bearing portion 52 may alternatively be defined between the upper surface of the cap 26 and the lower surface of the shaft annular portion 37.

As described above, a gap in the form of a bladder and including the radial bearing portion 51 and the thrust bearing portion 52 is defined between a combination of the sleeve 25 and the cap 26 and a combination of the shaft 31 and the shaft annular portion 37. This gap includes a thrust gap defined between the upper surface or the lower surface of the shaft annular portion 37 and a surface of the sleeve 25 or of the cap 26 which is axially opposite to the shaft annular portion 37, and a radial gap defined between the outer circumferential surface of the shaft 31 and a surface of the sleeve 25 which is radially opposite to the shaft 31. The lubricating oil 50 is continuously arranged in the gap including the thrust gap and the radial gap. The shaft 31 is supported through the lubricating oil 50 to be rotatable with respect to the sleeve 25 and the cap 26. In a situation in which the lubricating oil 50 has been fully arranged in the gap, a liquid surface of the lubricating oil 50 is defined only in the vicinity of the upper end portion of the sleeve 25 between the outer circumferential surface of the shaft 31 and the inner circumferential surface of the sleeve 25, that is, only at an upper end portion of the radial gap or in the vicinity of the upper end portion of the radial gap. That is, a bearing structure of this motor 1 is arranged to have a so-called full-fill structure, in which the liquid surface of the lubricating oil 50 is defined at only one position. Adoption of the full-fill structure, in which the lubricating oil 50 is sufficiently arranged between the stationary portion 2 and the rotating portion 3, contributes to more effectively preventing or reducing wobbling of the rotating portion 3 due to the orientation in which the motor 1 is installed and/or vibration, and also contributes to preventing a contact between the stationary portion 2 and the rotating portion 3 when a shock is applied to the motor 1 during the rotation of the motor 1.

As described above, a fluid dynamic bearing is defined by the combination of the sleeve 25 and the cap 26 of the stationary portion 2, the combination of the shaft 31 and the shaft annular portion 37 of the rotating portion 3, and the lubricating oil 50 arranged therebetween. The rotating portion 3 rotates about the central axis 9 while being supported by the fluid dynamic bearing. Thus, a vibration produced while the motor 1 is running is not easily transferred to the flywheel 35, which leads to a reduction in vibration of the flywheel 35. As a result, light can be guided with high accuracy, with travel of the light being affected to a limited degree. Note that the rotating portion 3 may alternatively be supported to be rotatable with respect to the stationary portion 2 using another bearing, such as, for example, a ball bearing or a plain bearing, instead of the fluid dynamic bearing.

### 1-3. Structure of Outer Circumferential Portion of Rotating Portion

Next, the structure of an outer circumferential portion of the rotating portion 3 of the motor 1 will now be described in detail below. The following description will be made with reference to FIGS. 1 and 2 appropriately.

Referring to FIG. 2, the yoke 33 is arranged radially outward in a lower portion of the rotating portion 3. An outer circumferential surface, a portion of an upper surface, and a portion of a lower surface of the yoke 33 are exposed to an outside when the yoke 33 is not covered with the first and second seal portions 61 and 62, which will be described below. As suggested above, the yoke 33 is made of a metal, such as, for example, iron, and at least a portion of the lower surface of the yoke 33 defines a first metal surface 331 made of the metal. At least one of the upper surface and the outer circumferential surface of the yoke 33 defines a second metal surface 332 made of the metal.

Each of the first and second metal surfaces 331 and 332 according to the present preferred embodiment is a cut surface on which a surface treatment process has not been performed. The first metal surface 331 has a reflectivity higher than a reflectivity of an outer circumferential surface of the flywheel 35 and a reflectivity of a surface of the first seal portion 61, which will be described below. The second metal surface 332 has a reflectivity higher than the reflectivity of the outer circumferential surface of the flywheel 35 and a reflectivity of a surface of the second seal portion 62, which will be described below. As described above, the flywheel 35 according to the present preferred embodiment is made of a resin, and each of the first and second metal surfaces 331 and 332 is made of a metal, such as, for example, iron. Therefore, the reflectivity of the outer circumferential surface of the flywheel 35 is lower than the reflectivity of each of the first and second metal surfaces 331 and 332. Note that a coating having a reflectivity lower than the reflectivity of the first metal surface 331 and the reflectivity of the second metal surface 332 may be applied on the outer circumferential surface of the flywheel 35 instead of or in addition to the flywheel 35 being made of a resin. Also note that a tape made of a material having a low reflectivity may be stuck on the outer circumferential surface of the flywheel 35.

As mentioned above, the motor 1 is installed in the casing, and is used in an apparatus designed to guide light. A mirror (not shown) is installed in the flywheel 35 of the rotating portion 3 to reflect light emitted from a light source. If the first and second metal surfaces 331 and 332, each of which has a high reflectivity, were exposed to the outside, a portion of the light emitted from the light source would be reflected by the first metal surface 331 or the second metal surface 332. Then, the reflected light would cause a diffuse reflection inside of the casing. Thus, the light reflected by the mirror and the light reflected by the first metal surface 331 or the second metal surface 332 might intermingle to spoil a wanted function to be carried out by the reflected light.

Referring to FIG. 2, in the present preferred embodiment, the first seal portion 61 is arranged to cover an area extending from a position lower than an upper end portion of the outer circumferential surface of the yoke 33 up to and including at least a portion of the first metal surface 331 defined in the lower surface of the yoke 33. The first seal portion 61 is a heat-shrinkable tube made of a resin. The first seal portion 61 is positioned so as to extend in an annular shape around the yoke 33, and is then caused to thermally shrink to attach the first seal portion 61 to the yoke 33 so as to fit the shape of the yoke 33. This reduces or eliminates the possibility that the first seal portion 61 will be detached or fly away. In addition, the first seal portion 61 is caused to thermally shrink with a lower portion of the first seal portion 61 being caught on the lower surface of the yoke 33, and this contributes to preventing the first seal portion 61 from moving upward in the axial direction. Further, the first seal portion 61 is caused to thermally shrink without the first seal portion 61 overlapping with the groove portion 321 when viewed in a radial direction, and this contributes to preventing an upper portion of the first seal portion 61 from being pulled into the groove portion 321 to cause a lower end portion of the first seal portion 61 to move upward. The likelihood that the first metal surface 331 will be exposed to the outside after the thermal shrinkage can thus be reduced. After the thermal shrinkage of the first seal portion 61, an upper end portion of the first seal portion 61 lies axially below the upper end portion of the yoke 33 as mentioned above.

Further, in the present preferred embodiment, the second seal portion 62 is arranged to cover an area extending from a position higher than a lower end portion of the outer circumferential surface of the flywheel 35 through the outer circumferential surface of the rotor hub portion 32 to a position higher than a lower end portion of the outer circumferential surface of the yoke 33. The second seal portion 62 is a heat-shrinkable tube made of a resin. The second seal portion 62 is positioned so as to extend in an annular shape around the upper end portion of the yoke 33 and a space axially above the upper end portion of the yoke 33, and is then caused to thermally shrink to attach the second seal portion 62 so as to fit the shapes of the yoke 33, the rotor hub portion 32, and the flywheel 35. This reduces or eliminates the possibility that the second seal portion 62 will be detached or fly away.

In addition, the second seal portion 62 is caused to thermally shrink with an axial middle of the second seal portion 62 lying in the vicinity of the upper end portion of the yoke 33, and thus, a lower portion of the second seal portion 62 is arranged to overlap with at least a portion of the first seal portion 61, including the upper end portion of the first seal portion 61, when viewed in the radial direction. As a result, a portion of the second metal surface 332 which is defined in the outer circumferential surface of the yoke 33 is completely covered with at least one of the first and second seal portions 61 and 62, each of which has a reflectivity lower than that of the second metal surface 332. In addition, the second seal portion 62 is arranged radially outside of a portion of the second metal surface 332 which is defined in the upper surface of the yoke 33, and this contributes to preventing the second metal surface 332 from being exposed to the outside.

Thus, light coming toward the yoke 33 from around the yoke 33 is blocked by at least one of the first and second seal portions 61 and 62, and this contributes to preventing the light from reaching the first metal surface 331 or the second metal surface 332, which is defined in at least one of the upper surface, the lower surface, and the outer circumferential surface of the yoke 33. As mentioned above, the reflectivity of the first seal portion 61 is lower than the reflectivity of the first metal surface 331 and the reflectivity of the second metal surface 332. The reflectivity of the second seal portion 62 is lower than the reflectivity of the first metal surface 331 and the reflectivity of the second metal surface 332. Thus, the coming light is absorbed by a surface of at least one of the first and second seal portions 61 and 62, and this contributes to preventing a diffuse reflection of the light inside the casing due to a reflection of the light by a surface of the yoke 33. It is desirable that the surface of each of the first and second seal portions 61 and 62 be in a color that does not easily allow reflection, such as black, dark green, gray, or the like, and that each of the first and second seal portions 61 and 62 be made of an opaque material, and be arranged to have a thickness of 30 μm or more and sufficient strength.

Further, in the present preferred embodiment, the outer circumferential surface of the rotor hub portion 32, which is made of the stainless metal, the aluminum alloy, or the like, is not exposed to the outside by being covered with the second seal portion 62. Each of the reflectivity of the first seal portion 61 and the reflectivity of the second seal portion 62 is lower than a reflectivity of the outer circumferential surface of the yoke 33 and a reflectivity of the outer circumferential surface of the rotor hub portion 32. This contributes to preventing a diffuse reflection of light inside the casing due to a reflection of the light coming from the light source by the outer circumferential surface of the rotor hub portion 32. Further, in the present preferred embodiment, the second seal portion 62 is arranged to cover an area extending up to and including at least a portion, including the lower end portion, of the outer circumferential surface of the flywheel 35. This contributes to preventing the light coming from the light source from reaching an axial gap between an upper end portion of the rotor hub portion 32 and a lower end portion of the flywheel 35, and from being reflected by an upper surface of the rotor hub portion 32 to cause a diffuse reflection of the light inside the casing. As described above, the groove portion 321 is defined in the outer circumferential surface of the rotor hub portion 32. After the thermal shrinkage of the second seal portion 62, within the groove portion 321, a portion of the second seal portion 62 overlaps with at least a portion of the rotor hub portion 32 when viewed in the radial direction.

### 2. Example Modifications

While preferred embodiments of the present invention have been described above, it will be understood that the present invention is not limited to the above-described preferred embodiments.

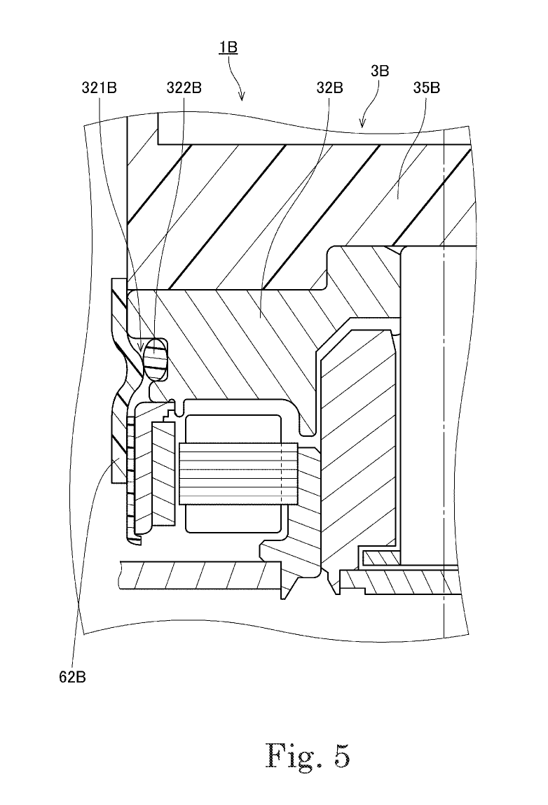

FIG. 5 is a partial vertical sectional view of a motor 1B according to a modification of the above-described first preferred embodiment. In the modification illustrated in FIG. 5, a rotor hub portion 32B further includes a balance correction member 322B arranged at a circumferential position within a groove portion 321B. The balance correction member 322B is arranged to fulfill the role of correcting balance of a center of gravity of a rotating portion 3B. Use of the balance correction member 322B makes it possible to correct the balance of the center of gravity of the rotating portion 3B after a flywheel 35B is fixed to the rotor hub portion 32B. This will make rotation of the motor 1B, which has the flywheel 35B installed therein, more stable. In addition, after being arranged within the groove portion 321B, the balance correction member 322B is covered by a second seal portion 62B from radially outside. That is, the balance correction member 322B is arranged radially inside of the second seal portion 62B. This contributes to more securely holding the balance correction member 322B.

As described above, in an outer circumferential surface of the rotor hub portion 32B, the groove portion 321B is extending in the circumferential direction over an entire circumferential extent of the rotor hub portion 32B. This makes it possible to arbitrarily choose the number of balance correction members 322B and the circumferential position(s) of the balance correction member(s) 322B, and this leads to improved operating efficiency. Note, however, that the groove portion 321B may alternatively be defined by a cut or cuts arranged at only one or more circumferential positions in the outer circumferential surface of the rotor hub portion 32B.

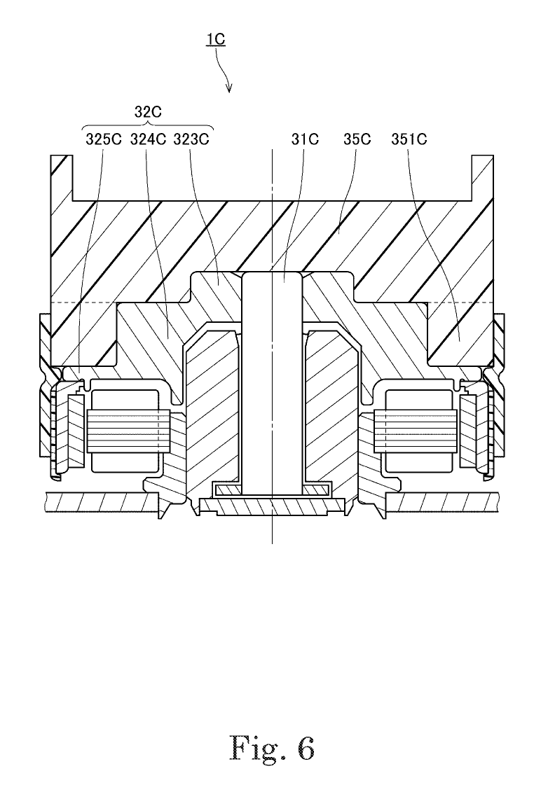

FIG. 6 is a vertical sectional view of a motor 1C according to another modification of the above-described first preferred embodiment. In the modification illustrated in FIG. 6, a rotor hub portion 32C includes a joining portion 323C, a cylindrical portion 324C, and a flange portion 325C. The joining portion 323C is arranged most radially inward in the rotor hub portion 32C, and is fixed to an outer circumferential surface of a shaft 31C. The cylindrical portion 324C is extending in the axial direction to assume a cylindrical shape radially outside of the joining portion 323C. The flange portion 325C is extending radially outward from a lower portion of the cylindrical portion 324C.

In the modification illustrated in FIG. 6, a flywheel 35C includes an inertia portion 351C arranged to project downward in a radially outer portion thereof. The inertia portion 351C is an annular portion arranged radially outside of the cylindrical portion 324C and axially above the flange portion 325C. A lower surface of the inertia portion 351C is arranged to be in contact with an upper surface of the flange portion 325C. In addition, the inertia portion 351C is fixed to an outer circumferential surface of the cylindrical portion 324C and the upper surface of the flange portion 325C through, for example, an adhesive. Thus, the flywheel 35C is more securely fixed to the rotor hub portion 32C, and is more stably held while the motor 1C is running.

Note that the inertia portion and the flywheel may alternatively be defined by separate members. Also note that the inertia portion may be made of a metal, such as, for example, stainless steel, and have a specific gravity greater than that of each of the flywheel and the rotor hub portion. This will lower a center of gravity of a rotating portion 3C including the inertia portion, resulting in more stable posture of the rotating portion 3C. Also note that the flywheel may be a resin injection-molded article produced with the inertia portion as an insert. In this case, for example, a molten resin is poured into a cavity in a mold with the inertia portion arranged in the mold, and the resin is cured to complete manufacture of the flywheel. This will accomplish molding of the flywheel and fixing of the flywheel to the inertia portion at the same time. Thus, a reduction in the number of processes to manufacture the motor can be achieved. Moreover, the flywheel and the inertia portion can be fixed to each other with increased strength.

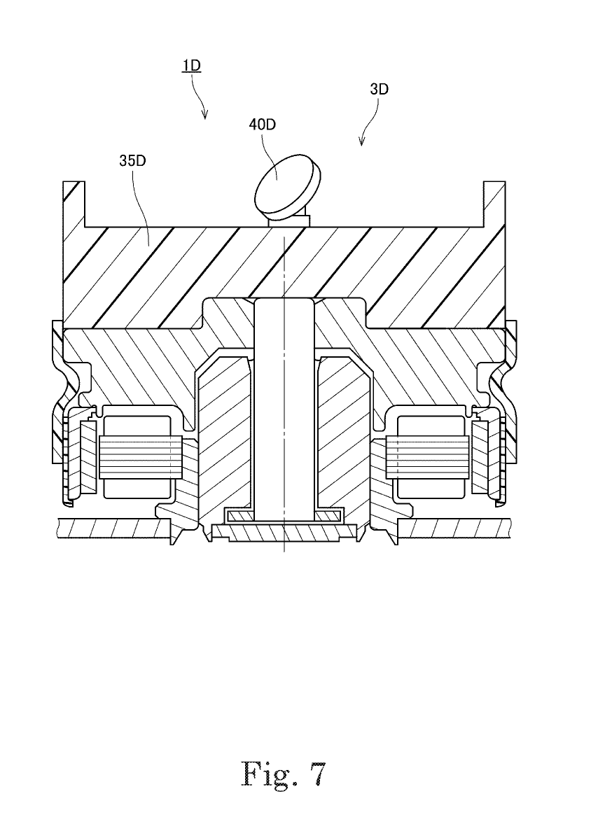

FIG. 7 is a vertical sectional view of a motor 1D according to yet another modification of the above-described first preferred embodiment. In the modification illustrated in FIG. 7, a rotating portion 3D includes a mirror 40D. The mirror 40D is supported by a flywheel 35D. Once the motor 1D is driven, the mirror 40D is caused to rotate together with the flywheel 35D. This allows light coming toward the flywheel 35D to be reflected while the light is deflected with a fixed cycle.

In each of the above-described preferred embodiment and the above-described modifications thereof, each of the first and second seal portions is a heat-shrinkable tube made of a resin. Note, however, that each of the first and second seal portions may alternatively be a tape made of a resin. In addition, it may be sufficient if each of the first and second metal surfaces is covered by at least one of the first and second seal portions over the entire circumferential extent thereof, and both circumferential end portions of each of the first and second seal portions may overlap with each other or be slightly displaced from each other. Also note that each of the first and second metal surfaces may be covered with multiple layers of the first seal portion or the second seal portion over the entire circumferential extent thereof.

It is desirable that the surface of each portion have a lower reflectivity to more effectively prevent a diffuse reflection inside the casing. Accordingly, it is desirable, for example, that the lower surface and the inner circumferential surface (i.e., a portion not being covered with the first seal portion) of the yoke are roughened. Examples of roughening methods include a method of forming processing marks on the surface with a cutting process or press working; a method of performing shot blasting of blowing an abrasive, such as, for example, sand, against the surface; a method of applying a resin in which minute particles are dispersed onto the surface and solidifying the resin; a method of applying a chemical solvent onto the surface to dissolve the surface; and a method of spraying a chemical solvent onto the surface using a spray. Note that, alternatively, a plating process and an oxidation treatment may be performed on the lower surface and the inner circumferential surface of the yoke. Also note that a member made of a metal or a resin and having a low reflectivity may be fixed to the lower surface and the inner circumferential surface of the yoke, that a coating having a low reflectivity may be applied onto the lower surface and the inner circumferential surface of the yoke, and that a tape made of such a material may be stuck on the lower surface and the inner circumferential surface of the yoke.

Note that details of the structure and the shape of a motor according to a preferred embodiment of the present invention may differ from details of the structure and the shape of each motor as illustrated in the accompanying drawings of the present application. Also note that features of the above-described preferred embodiments and the modifications thereof may be combined appropriately as long as no conflict arises.

Preferred embodiments of the present invention are applicable to, for example, motors.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor comprising:
a stationary portion including a stator; and
a rotating portion supported to be rotatable about a central axis extending in a vertical direction with respect to the stationary portion; wherein
the rotating portion includes:
a rotor hub portion extending in an annular shape around the central axis;
a magnet including a pole surface radially opposite to the stator;
a yoke fixed to a radial outside of the magnet and connected to the rotor hub portion;
a first seal portion extending in an annular shape around the yoke; and
a flywheel located on one side of the rotor hub portion in an axial direction;
at least a portion of a lower surface of the yoke defines a first metal surface that has a reflectivity higher than a reflectivity of an outer circumferential surface of the flywheel and a reflectivity of the first seal portion; and
at least a portion of the first metal surface is covered with the first seal portion.

2. The motor according to claim 1, wherein the first seal portion includes a heat-shrinkable tube.

3. The motor according to claim 2, wherein an upper end portion of the first seal portion is axially below an upper end portion of the yoke.

4. The motor according to claim 1, wherein the reflectivity of the first seal portion is lower than a reflectivity of an outer circumferential surface of the yoke and a reflectivity of an outer circumferential surface of the rotor hub portion.

5. The motor according to claim 1, wherein
the rotating portion further includes a second seal portion extending in an annular shape around an upper end portion of the yoke and/or a space axially above the upper end portion of the yoke;
at least one of an upper surface of the yoke and an outer circumferential surface of the yoke defines a second metal surface that has a reflectivity higher than the reflectivity of the outer circumferential surface of the flywheel and a reflectivity of the second seal portion; and
the second seal portion overlaps with at least a portion of the first seal portion when viewed in a radial direction.

6. The motor according to claim 5, wherein the second seal portion includes a heat-shrinkable tube.

7. The motor according to claim 5, wherein the second seal portion overlaps with at least a portion of the rotor hub portion when viewed in the radial direction.

8. The motor according to claim 5, wherein the reflectivity of the second seal portion is lower than a reflectivity of an outer circumferential surface of the yoke and a reflectivity of an outer circumferential surface of the rotor hub portion.

9. The motor according to claim 5, wherein at least a portion of the outer circumferential surface of the flywheel is covered with the second seal portion.

10. The motor according to claim 5, wherein each of the first and second seal portions is made of a resin.

11. The motor according to claim 5, wherein a surface of each of the first and second seal portions is black in color.

12. The motor according to claim 7, wherein
the rotor hub portion includes a groove portion recessed radially inward and defined in at least a portion of an outer circumferential surface of the rotor hub portion; and
the second seal portion includes a portion that overlaps with at least a portion of the rotor hub portion when viewed in the radial direction within the groove portion.

13. The motor according to claim 12, wherein the rotor hub portion further includes a balance corrector located within the groove portion and radially inside of the second seal portion.

14. The motor according to claim 12, wherein, in the outer circumferential surface of the rotor hub portion, the groove portion extends in a circumferential direction over an entire circumferential extent of the rotor hub portion.
